(19) United States
(12) Patent Application Publication
(10) Pub. No.: US 2013/0159470 A1
(43) Pub. Date: Jun. 20, 2013

(54) DOWNLOAD SYSTEM AND METHOD USING SAME

(71) Applicant: PENG WANG, Shenzhen City (CN)

(72) Inventor: PENG WANG, Shenzhen City (CN)

(21) Appl. No.: 13/629,687

(22) Filed: Sep. 28, 2012

(30) Foreign Application Priority Data
Dec. 16, 2011 (CN) 201110424145.0

(51) Int. Cl. G06F 15/16

(52) U.S. Cl. 709/219

(57) ABSTRACT

A download system includes a first communication device and a second communication device. The first communication device includes a first account with a first residual allowance data to access a network storage device. The second communication device includes a second account with a second residual allowance data to access the network storage device. The download system further includes a download module for sharing the first residual allowance data and the second residual allowance data to download a target data from the network storage device.

### TECHNICAL FIELD

Embodiments of the present disclosure relate to a download system including a first communication device and a second communication device and a method using the same to download a target data.

### DESCRIPTION OF RELATED ART

With the popularity of mobile communications, there are many telecommunication companies providing services of prepaid broadband access to network storage devices. Users may have credit or debit accounts with the telecommunication company whereby a limited amount of data is authorized to be used each month. However, some users may not use all of their allocated amount, while other users may pay additional fee for exceeding their allocated amount. Therefore, an improved solution for efficiently using the allocated amount of data of the communication devices is desired.

Thus, a new communication device is desired to overcome the above-described shortcomings

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a schematic block diagram illustrating one embodiment of a communication system including a first communication device and a second communication device.

FIG. 2 is a schematic block diagram illustrating one embodiment of functional modules of the first communication device of FIG. 1.

FIG. 3 is a flowchart of one embodiment showing a download method of the communication system of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include compact discs (CDs), digital video discs (DVDs), BLU-RAY disks, Flash memory, and hard disk drives.

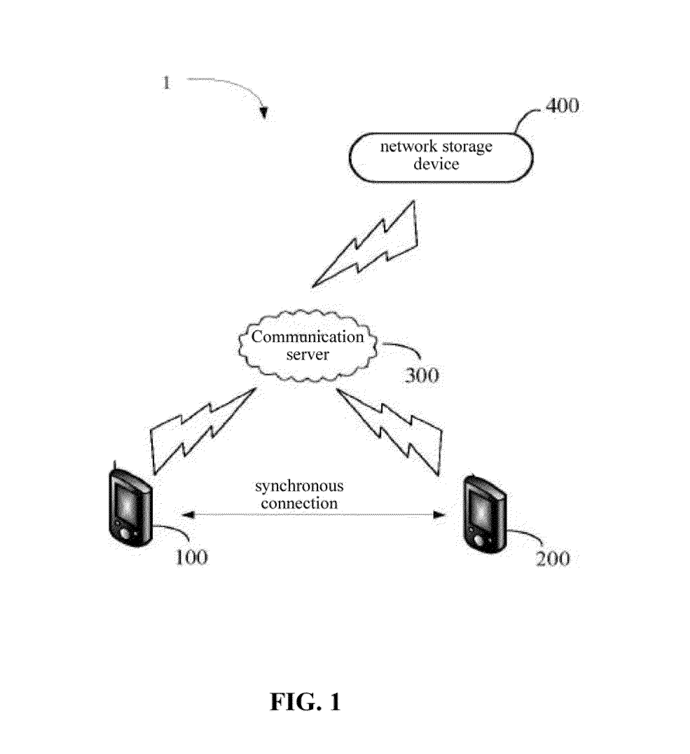

FIG. 1 is a schematic block diagram illustrating one embodiment of a communication system 1. The communication system 1 includes a first communication device 100 and a second communication device 200. Both the first communication device 100 and the second communication device 200 may be any kind of communication device, such as a smart phone, a personal digital assistant, a mobile computer, or other similar device. In the embodiment, a communication server 300 may for example be provided by a telecommunication company. The communication server 300 provides services of prepaid broadband access to the first communication device 100 and the second communication device 200. The first communication device 100 and the second communication device 200 can use the services of prepaid broadband access to access a network storage device 400 and download documents, music, movies, and other types of data, from the network storage device 400 via wireless communication technology. In one embodiment, the wireless communication technology may be selected from a group consisting of a global system for a mobile communication (GSM) technology, a code division multiple access (CDMA) technology, or a wide band CDMA (WCDMA) technology, for example.

The first communication device 100 and the second communication device 200 have a prepaid account with the telecommunication company whereby a limited amount of data is deducted from the accounts as the communication services are utilized. In one embodiment, if the first communication device 100 retains a first residual allowance data to access the network. The second communication device 200 retains a second residual allowance data to access the network. The first communication device 100 can build a synchronous connection with the second communication device 200 for sharing the first residual allowance data and the second residual allowance data to download a target data. In the embodiment, the target data may be one or more executable files, music files, movie files, or image files which are greater or less than each of the first residual allowance data and the second residual allowance data.

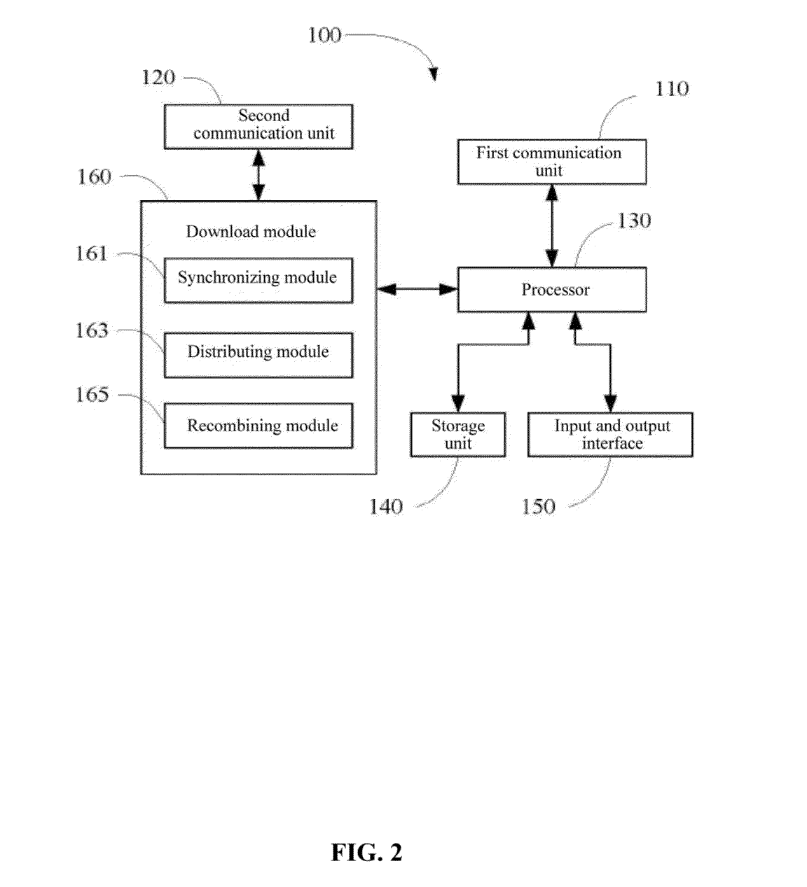

FIG. 2 is a schematic block diagram illustrating one embodiment of the first communication device 100 of FIG. 1. In this embodiment, the first communication device 100 and the second communication device 200 have the same configuration and only the first communication device 100 is detailed below as an example.

The first communication device 100 includes a first communication unit 110, a second communication unit 120, a processor 130, a storage unit 140, an input-output interface 150, and a download module 160.

The input-output interface 150 receives commands or instructions such as a web address from users for accessing the target data stored in the network storage device 400.

The first communication unit 110 is configured to access the network storage device 400 via the communication server 300. In one embodiment, the first communication unit 110 may be selected from a group consisting of a global system for a mobile communication (GSM) unit, a code division multiple access (CDMA) unit, or a wide band CDMA (WCDMA) unit.

The second communication unit 120 is configured to build a synchronous connection between the first communication device 100 and the second communication device 200 for the transmission of data. In one embodiment, the second communication unit 120 may be selected from BLUETOOTH communication unit, infrared communication unit, wireless-fidelity (WI-FI) communication unit, or Universal Serial BUS (USB) communication unit or other wireless communication unit.

The storage unit 140 stores a network connection link such as an universal resource locator (URL) for a target data, downloaded segments of target data, the first residual allowance data and the second residual allowance data. In one embodiment, the storage unit 140 can be selected from a group consisting of CDs, DVDs, BLU-RAY disks, Flash memory, and hard disk drives.

The download module 160 is configured for sharing the first residual allowance data and the second residual allowance data to download the target data from the network storage device 400. In one embodiment, the download module 160 is executed by the processor 130 for managing a download process of the communication device 100 if accessing the network storage device 400 via the communication server 300. The download module 160 may include a plurality of programs in the form of one or more computerized instructions stored in the storage unit 140 and executed by the processor 130 to perform operations of the communication device 100. In the embodiment, the download module 160 includes a synchronizing module 161, a distributing module 163, and a recombining module 165. FIG. 2 is one example of the communication device 100. The communication device 100 can include more or fewer components than those shown in the embodiment, or have a different configuration of the components.

The synchronizing module 161 controls the second communication unit 120 and builds a synchronous communication between the first communication device 100 and the second communication device 200 if the second communication device 200 agrees to share the second residual allowance data with the first communication device 100 to download the target data.

The distributing module 163 pre-divides the target data to be downloaded into at least a first segment and a second segment, instructs the first communication device 100 to download the first segment, and instructs the second communication device 200 to download the second segment. In this embodiment, the first residual allowance data is greater than the first segment and less than the target data and the second residual allowance data is greater than the second segment and less than the target data. In other embodiments, the first segment and the second segment can be calculated and divided according to a proportion of the first residual allowance data and the second residual allowance data.

The recombining module 165 combines the downloaded first segment and the downloaded second segment to regenerate the target data. The processor 130 stores the regenerated target data into the storage unit 140.

In some embodiments, the first communication device 100 can build a synchronous communication with two or more second communication devices 200 for sharing the first residual allowance data and two or more second residual allowance data to download the target data. Under this condition, the distributing module 163 pre-divides the target data into a first segment and two or more second segments, instructs the first communication device 100 to download the first segment, and instructs each one of the second communication devices 200 to download one of the second segments. The recombining module 165 regenerates the target data using the downloaded first segment and the downloaded two or more second segments.

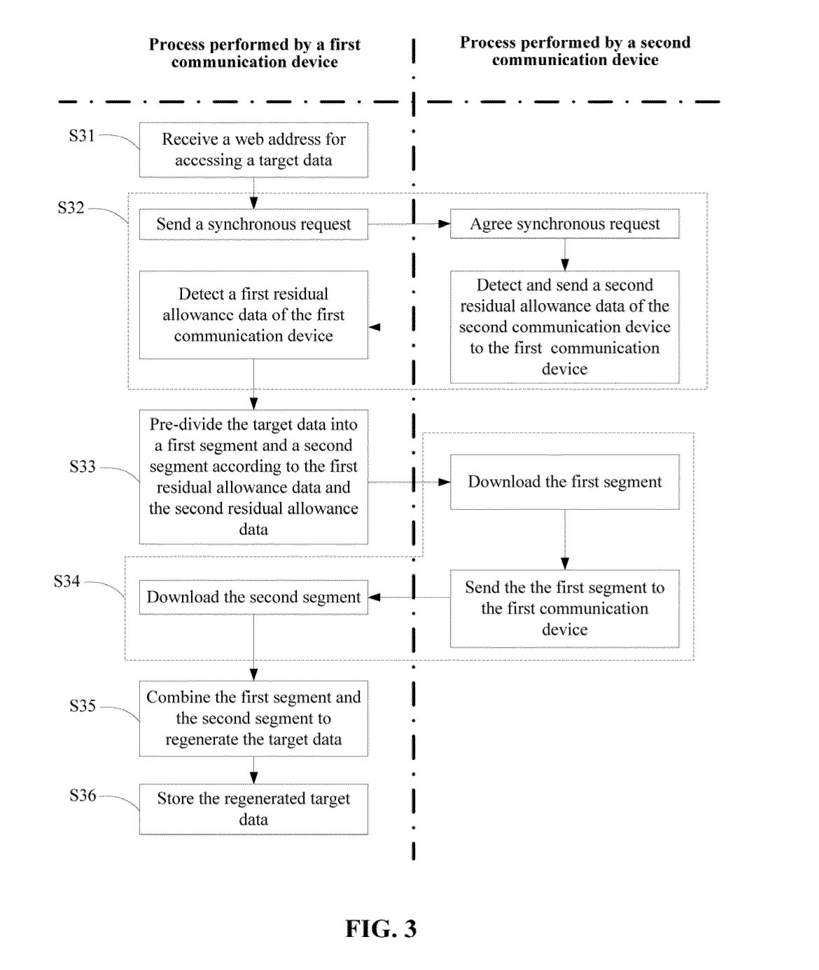

FIG. 3 is a flowchart of one embodiment showing a download method of the communication system of FIG. 1. The method is typically carried out using the communication system 1 to share the first residual allowance data and the second residual allowance data to download the target data. Depending on the embodiment, additional steps may be added, others removed, and the ordering of the steps may be changed.

In step S31, the input-output interface 150 receives commands or instructions for accessing a web address or URL of the target data stored in the network storage device 400. In detail, if a user wants to download a target data, the web address for obtaining and downloading the target data may be inputted via the input-output interface 150 and executed by the processor 130. The processor 130 starts a web browser to access the network storage device 400 where the target data is stored in. The processor 130 also records the web address and detects the package size of the target data.

In step S32, the synchronizing module 161 builds a synchronous communication between the first communication device 100 and the second communication device 200 using the second communication unit 120 if the second communication device 200 agrees to share second residual allowance data with the first communication device 100. In detail, the synchronizing module 161 first generates and sends a synchronous request to the second communication device 200 according to the package size of the target data. If the second communication device 200 agrees with the synchronous request, the synchronous communication between the first communication device 100 and the second communication device 200 is built. The synchronizing module 161 then sends the web address to the second communication device 200, and the second communication device 200 detects and sends the second residual allowance data relating to the prepaid account of the second communication device 200 back to the first communication device 100. After receiving the second residual allowance data, the first communication device 100 detects and confirms the first residual allowance data relating to the prepaid account of the first communication device 100. In alternative embodiments, the first communication device 100 may detect and confirm the first residual allowance data before receiving the second residual allowance data.

In step S33, the distributing module 163 pre-divides the target data into at least a first segment and a second segment. In one embodiment, the first residual allowance data is greater than or equal to the first segment and less than the target data, and the second residual allowance data is greater than the second segment and less than the target data. In other embodiments, the first segment and the second segment can be calculated and divided according to a proportion of the first residual allowance data and the second residual allowance data.

In alternative embodiments, if the first residual allowance data plus the second residual allowance data is less than the target data, the synchronizing module 161 may build a synchronous communication between the first communication device 100 and a third communication device if the third communication device agrees to share its residual allowance data with the first communication device 100.

In step S34, the first communication device 100 downloads the first segment, and the second communication device 200 downloads the second segment using the received web address and transmits the second segment to the first communication device 100 via synchronous communication.

In step S35, the recombining module 165 combines the first segment and the second segment to regenerate the target data.

In step S36, the processor 130 stores the regenerated target data into the storage unit 140.

Even though numerous characteristics and advantages of certain inventive embodiments have been set out in the foregoing description, together with details of the structures and functions of the embodiments, the disclosure is illustrative only; and changes may be made in detail, especially in the matter of arrangement of parts within the principles of present invention to the full extent indicated by the broad general meaning of the terms in which the appended claims are expressed.

What is claimed is:

1. A download system comprising a first communication device and a second communication device, the first communication device comprising a first account with a first residual allowance data to access a network storage device and the second communication device comprising a second account with a second residual allowance data to access the network storage device, the download system further comprising a download module for sharing the first residual allowance data and the second residual allowance data to download a target data from the network storage device.

2. The communication device of claim 1, wherein the first communication device further comprises a first communication unit to access the network storage device using the first residual allowance data.

3. The communication device of claim 2, wherein the first communication unit is selected from a group consisting of a global system for mobile communication (GSM) unit, a code division multiple access (CDMA) unit, and a wide band CDMA (WCDMA) unit.

4. The communication device of claim 1, wherein the first communication device further comprises a second communication unit to build a synchronous communication between the first communication device and the second communication device.

5. The communication device of claim 4, wherein the second communication unit is selected from a group consisting of a BLUETOOTH communication unit, an infrared communication unit, wireless-fidelity (WI-FI) communication unit, and a universal serial BUS (USB) communication unit.

6. The communication device of claim 4, wherein the download module controls the second communication unit to build the synchronous communication if the second communication device agrees to share the second residual allowance data with the first communication device.

7. The communication device of claim 6, wherein the download module pre-divides the target data to be downloaded into a first segment and a second segment, instructs the first communication device to download the first segment, and instructs the second communication device to download the second segment.

8. The communication device of claim 7, wherein the first segment and the second segment are divided according to a proportion of the first residual allowance data and the second residual allowance data.

9. The communication device of claim 7, wherein the first residual allowance data is greater than the first segment and less than the target data, and the second residual allowance data is greater than the second segment and less than the target data.

10. The communication device of claim 7, wherein the download module combines the downloaded first segment and the downloaded second segment to regenerate the target data.

11. The communication device of claim 10, further comprising a storage unit for storing the regenerated target data.

12. A download method comprising:
providing a first communication device comprising a first account with a first residual allowance data to access a network storage device;
providing a second communication device comprising a second account with a second residual allowance data to access the network storage device; and
sharing the first residual allowance data and the second residual allowance data to download a target data from the network storage device by a download module.

13. The method of claim 12, further comprising receiving commands or instructions of accessing a web address of the target data by an input-output interface.

14. The method of claim 12, further comprising accessing the network storage device to obtain the package size of the target data by a first communication unit.

15. The method of claim 12, further comprising sending a synchronous request and the web address from the first communication device to the second communication device, building a synchronous communication between the first communication device and the second communication device by a second communication unit if the second communication device agrees to share the second residual allowance data with the first communication device.

16. The method of claim 15, further comprising pre-dividing the target data into a first segment and a second segment according to a proportion of the first residual allowance data and the second residual allowance data by the download module.

17. The method of claim 16, further comprising downloading the first segment by the first communication device, and downloading the second segment by the second communication device.

18. The method of claim 17, further comprising combining the first segment and the second segment to regenerate the target data by a processor.

19. The method of claim 18, further comprising storing the regenerated target data into a storage unit by the processor.
